(19) United States
(12) Patent Application Publication
(10) Pub. No.: US 2010/0308182 A1
(43) Pub. Date: Dec. 9, 2010

(54) Systems and methods of deploying and securing temporary wires and extension cords

(76) Inventor: Eric Lahti, Lunenberg, MA (US)

Correspondence Address: Kenneth F. Kozik, 43 Mohawk Drive, Acton, MA, 01720-2343, US

(21) Appl. No.: 12/800,344

(22) Filed: May 13, 2010

Related U.S. Application Data
(60) Provisional application No. 61/185,294, filed on Jun. 9, 2009.

(51) Int. Cl. F16L 3/08

(52) U.S. Cl. 248/59; 248/58; 248/60; 248/63

(57) ABSTRACT

An apparatus includes a suspension end, the suspension end configured to link to a supporting fixture, and a mounting end connected to the suspension end, the mounting end comprising one or more hooks from which electrical wires and extension cords are suspended.

### CROSS-REFERENCE TO RELATED APPLICATIONS

This application claims the benefit of U.S. Provisional Application No. 61/185,294, filed on Jun. 9, 2009, titled SYSTEMS & METHODS OF DEPLOYING AND SECURING ELECTRICAL WIRES AND EXTENSION CORDS, which is incorporated by reference in its entirety.

### BACKGROUND OF THE INVENTION

The invention generally relates to work site safety and efficiency, and more particularly to systems and methods of deploying and securing temporary wires and extensions cords.

The modern construction site can inherently be a hazardous and congested work environment. Typically, teams of construction workers simultaneously work at large construction sites. These teams can include tradesmen, for instance, electricians, plumbers, iron workers, and welders, as well as laborers and other workers.

To accomplish their tasks and objectives, construction workers utilize various types of powered equipment, such as, power saws, temporary lighting, and so forth. Typically, the powered equipment is connected to one or more power sources by extension cords. The extension cords tend to be strewn over the ground, and can become entangled with one another.

Oftentimes, workers trip over the extension cords and suffer falls and other injuries. Adding to the hazard is the presence of heavy equipment at the construction site, such as scissor lifts, bulldozers, cranes, and so forth. Oftentimes, heavy equipment operators inadvertently drive over the extension cords resulting in severed electrical connections and increased risk of electrocution.

### SUMMARY OF THE INVENTION

In an aspect, the invention features an apparatus including a suspension end, the suspension end configured to link to a supporting fixture, and a mounting end connected to the suspension end, the mounting end comprising one or more hooks from which electrical wires and extension cords are suspended.

In another aspect, the invention features a portable apparatus for suspending and securing one or more electrical wires and extension cords above a work area, or at least off the ground, in a construction site. The apparatus can include a first end from which the apparatus can be suspended, and a second end having one or more hooks from which electrical wires and extension cords can be suspended.

One or more of the following features may be included in various embodiments.

A first end and a second end of the apparatus can be fused together, cast, or machined to form a single, rigid device.

A first end of the apparatus can be coupled to a second end of the apparatus through a connection link to form a flexible device.

A first end of the apparatus be coupled to a second end of the apparatus with a flexible connecting material.

Advantages of suspending and securing electrical wires and extension cords above a work area include reducing inherent safety hazards and risks to workers at construction sites and so forth.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIGS. 1A-1C illustrate exemplary embodiments of an apparatus configured in accordance with the present invention.

FIGS. 2A and 2B illustrate portions of an exemplary apparatus for use with an embodiment of the present invention.

FIGS. 3A-3C illustrate exemplary components that can be utilized in connection with an embodiment of the present invention.

FIGS. 4A and 4B illustrate portions of an exemplary apparatus for use with an embodiment of the present invention.

FIGS. 5A and 5B illustrate portions of an exemplary apparatus for use with an embodiment of the present invention.

FIGS. 6A and 6B illustrate an exemplary apparatus configured in accordance with an embodiment of the present invention.

FIGS. 7A and 7B illustrate portions of an exemplary apparatus for use with an embodiment of the present invention.

FIG. 8 illustrates an example construction site in which various embodiments of the present invention can be utilized.

Like reference numbers and designations in the various drawings indicate like elements.

### DETAILED DESCRIPTION

Generally, in one aspect, the present invention provides a portable apparatus for suspending and securing one or more electrical extension cords above a work area, or at least off the ground, in a construction site. Suspending and securing electrical wires and extension cords above a work area can reduce inherent safety hazards and risks to workers.

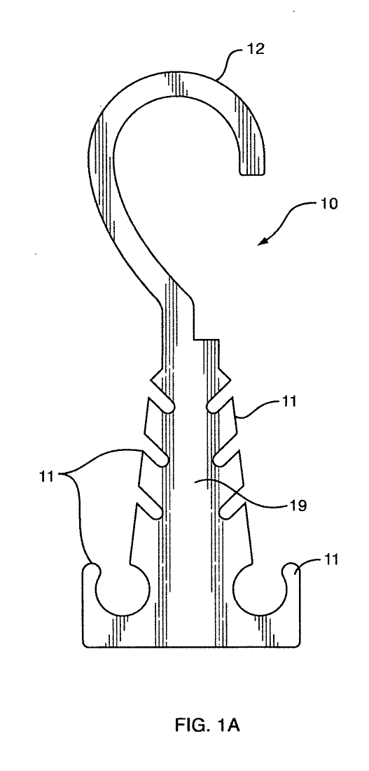

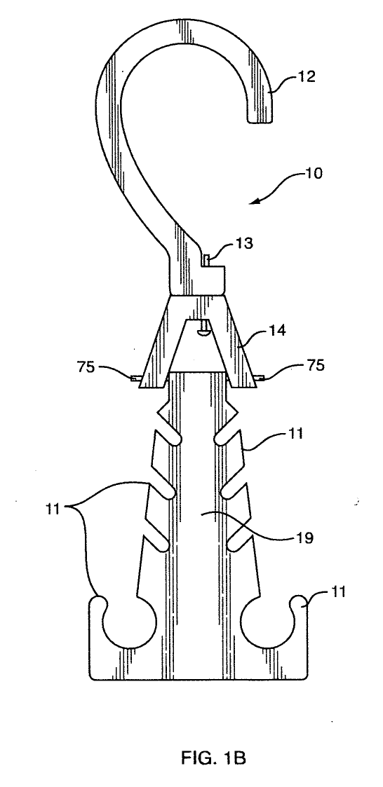

Referring to FIGS. 1A-1C, in various embodiments, apparatus 10 can include a first end 12 from which apparatus 10 can be suspended, and a second end 19 having one or more hooks 11 from which electrical wires and extension cords can be suspended. As shown in FIG. 1A, in an embodiment, the first end 12 and second end 19 of apparatus 10 can be fused together, cast, or machined to form a single, rigid device. Alternatively, as shown in FIG. 1B, the first end 12 can be coupled to the second end 19 through a connection link 14 to form a flexible device. In another embodiment illustrated in FIG. 1C, the first end 12 can be coupled to the second end 19 via a flexible connecting material 16. These and other embodiments are discussed in detail below.

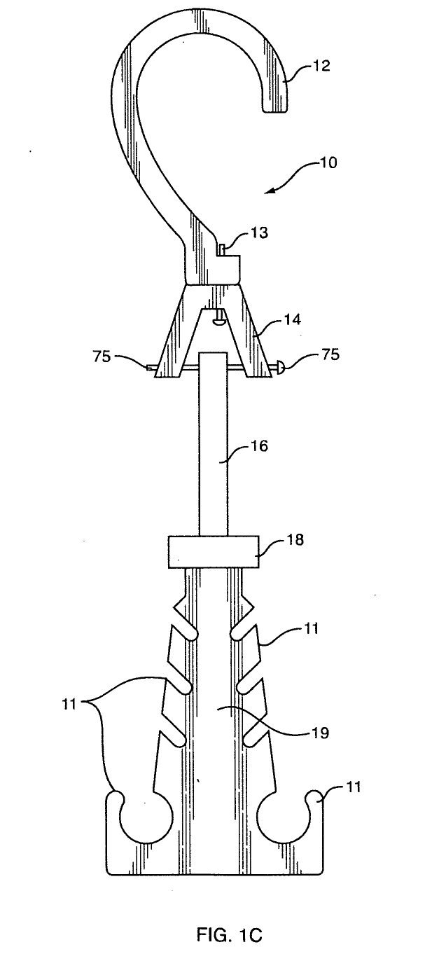

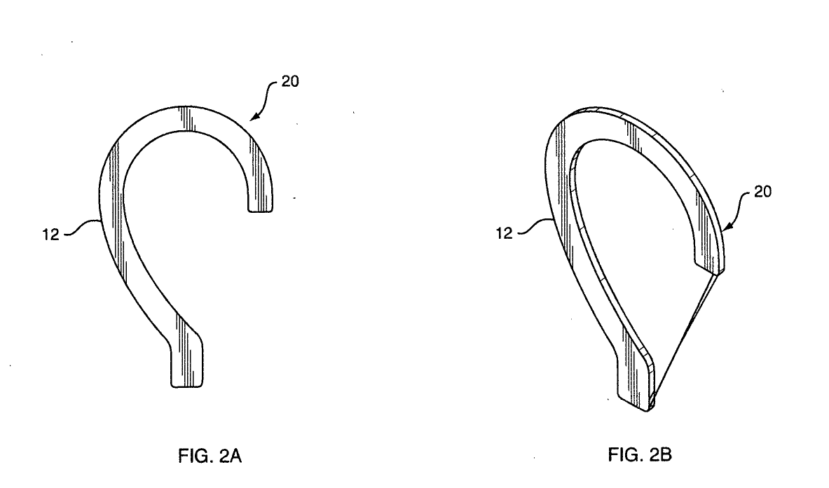

Referring to FIG. 2, in an embodiment, the first end 12 can be shaped like a hook 20, which can be utilized to suspend the entire apparatus 10 above a work area. For example, the hook 20 can be placed around a pipe, beam, or other fixture above the work area in a construction site. In an embodiment, the hook 20 may have a pointed end that can be utilized to fasten the apparatus 10 to a penetrable medium, such as a wooden I-beam, by forcing the pointed end into the penetrable medium.

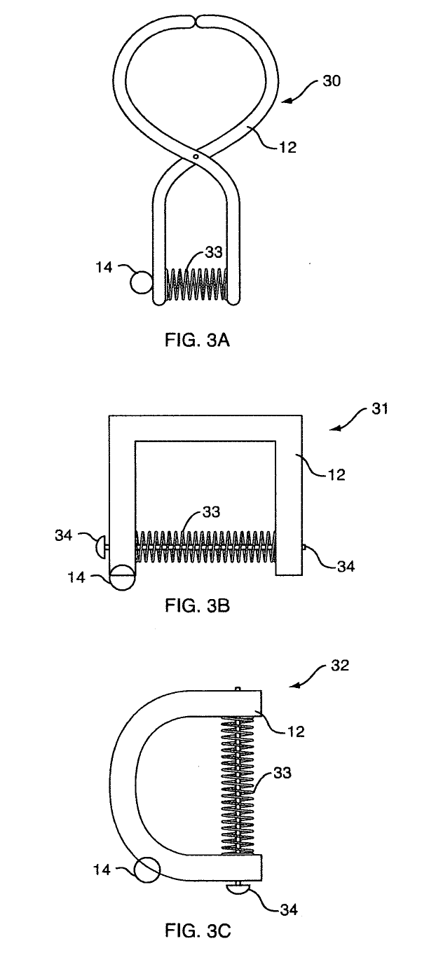

Referring to FIGS. 3A-3C, rather than a hook 20, the first end 12 may be designed and configured in a variety of shapes and sizes. For instance, in example hook 30 illustrated in FIG. 3A, the first end 12 can be a clasp, and may include a spring 33 or other tension mechanism to securely fasten the clasp about a pipe or other fixture above a work site. In operation, the spring 33 can be compressed by squeezing the clasp, which results in the clasp opening such that it can be placed around a supporting fixture, such as, a pipe. Upon release of the clasp, the spring 33 or other tension mechanism de-compresses thereby closing and securing the clasp around the supporting fixture.

Further, as shown in example hook 31 and example hook 32 illustrated in FIGS. 3B and 3C, respectively, the first end 12 can have a square shape or C-ring shape. Moreover, the first end 12 can include a pin 34 that can be removed or retracted to place the first end 12 about a fixture, and then replaced or released to secure the first end 12 around the fixture. The pin 34 may or may not include a spring 33 or other tension mechanism to securely fasten the pin 34 in place.

Regardless of the shape of the first end 12 as illustrated herein, it should be understood by those skilled in the art that the first end 12 can be implemented in a wide variety of shapes and sizes without deviating from the scope of the present invention. The first end 12 can be made of natural and man-made materials including wood, metal, glass, plastic, ceramic, carbon fiber, composites, and other suitable materials.

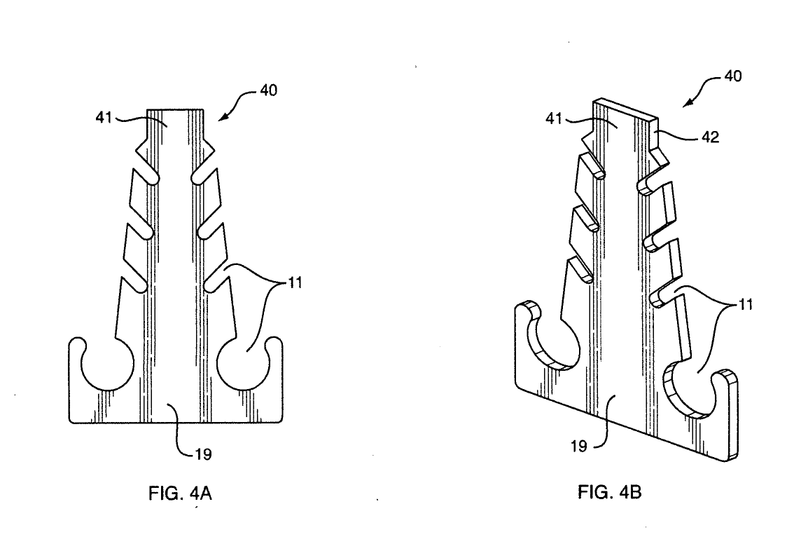

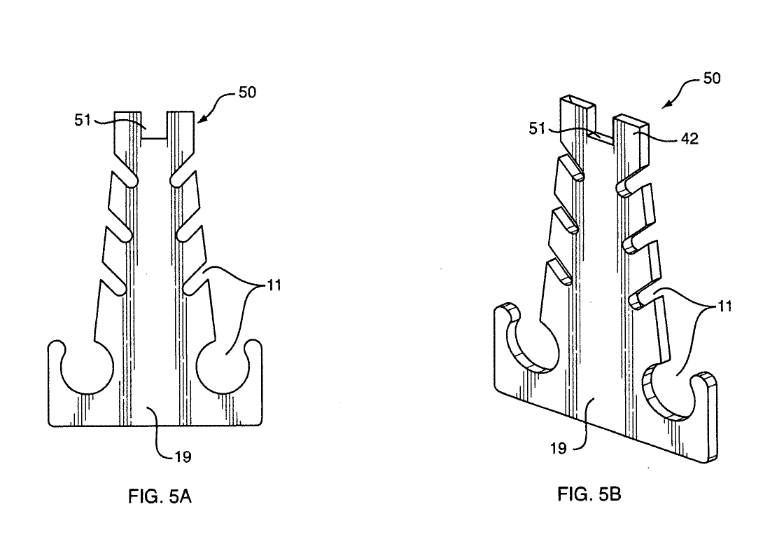

Referring to examples 40 and 50 illustrated in FIGS. 4 and 5 respectively, the second end 19 of apparatus 10 can include one or more notches or hooks 11. Each notch or hook 11 can be utilized to support and suspend an electrical wire or extension cord above a work area. The hooks 11 can be of various sizes to accommodate cords of varied diameters and sizes. Alternatively, instead of notches or hooks 11, the second end 19 can include clasps, rings, or other features that can securely grip and hold electrical wires and extension cords.

As shown in example 40, the second end 19 can include a insert 41 for coupling the second end 19 to the remainder of the apparatus 10. The insert 41 can include a passageway 42 through which a pin 75 (see FIG. 1B) can be passed to secure the second end to the apparatus 10. In another embodiment, shown in example 50, the second end 19 can include an aperture 51 for coupling the second end 19 to the remainder of apparatus 10. The second end 19 can be made of natural and man-made materials including wood, metal, glass, plastic, ceramic, carbon fiber, composites, and other suitable materials.

Referring to FIGS. 1A-1C, in an embodiment, the first end 12 and second end 19 may be fused directly together, or apparatus 10 can be machined as one unit from a single piece of material such as metal, wood, or plastic. In another embodiment, the first end 12 can be coupled to the second end 19 of apparatus 10 by a connecting material 16. The connecting material 16 may be flexible and can be a bungee cord, rope, chain, nylon string, metal cable, rubber strip, or any other material that is flexible and strong enough to support multiple electrical cords. In another embodiment, the connecting material 16 may not be flexible. Rather, the connecting material 16 may be a separate component that is rigid, and is fastened to the first end 12 and the second end 19. The length of the connecting material 16 can be provided in standard dimensions, or can be adjustable depending on a particular implementation.

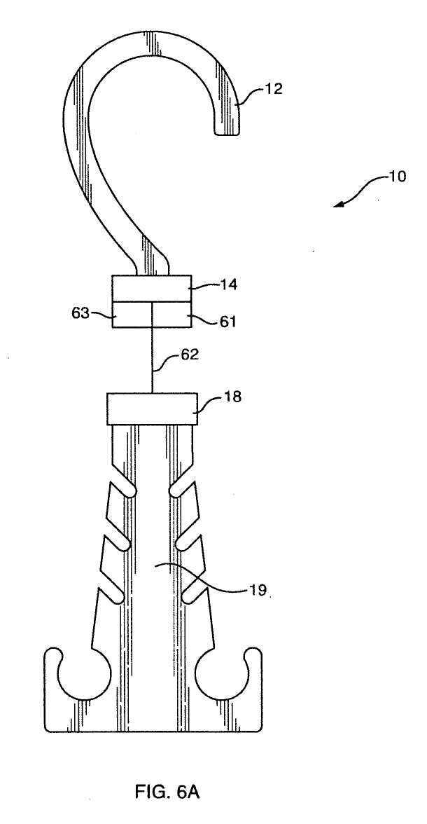

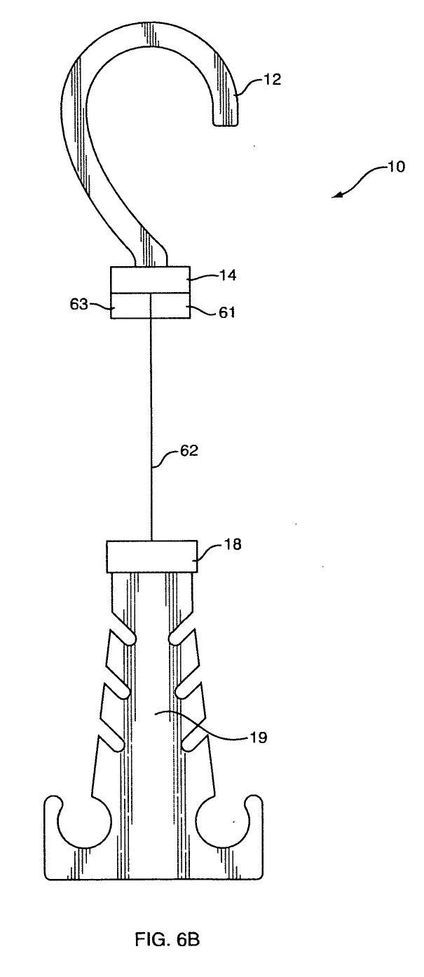

Referring to FIGS. 6A and 6B, in an embodiment, apparatus 10 may include an adjustable cable spool 61, which contains a quantity of coiled cable 62. The adjustable cable spool 61 can include a release button 63 that can be depressed by a user to release a desired length of cable 62. Such a feature can be useful when it may be necessary to position an electrical wire or extension cord at a particular height above a work area.

Regardless of whether the connecting material 16 is flexible or rigid, fixed length or adjustable length, in an embodiment, the connecting material 16 can be fastened to the first end 12 and second end 19 by various methods including gluing, welding, ultrasonic bonding, epoxy, nuts and bolts, or other fastening methods.

In another embodiment and with reference to FIGS. 1B-1C, apparatus 10 can include one or more connection links 14, 18 to couple the first end 12, connection material 16, and second end 19 together. Connection links 14, 18 can include a swivel mechanism to prevent twisting of the apparatus 10, excessive stresses, and entanglement of the electrical cords. Various swivel mechanisms can be utilized to achieve this objective.

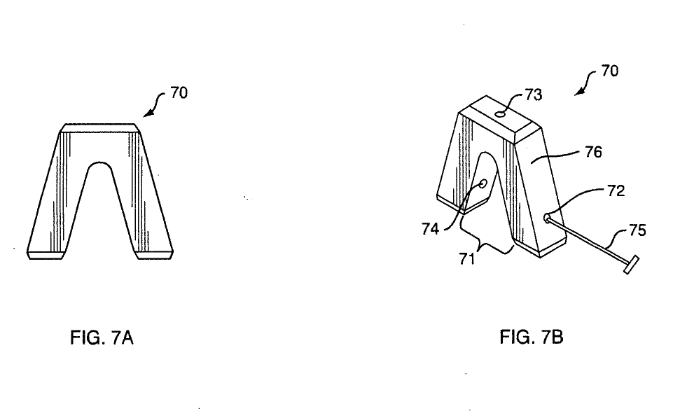

Referring to FIG. 7, in an embodiment, connection links 14 and 18 can be designed and configured as swivel mechanism 70. Specifically, swivel mechanism 70 can include a body portion 76 that can be made from the same or different material as that of the first end 12 and second end 19. The body portion can include a gap 71, and passageways 72, 73, and 74, through which pins 13, and 75 can be passed to secure portions of apparatus 10. For example, insert 41 (see also, FIG. 1B, 1C, and 4) on the second end 19 can be placed in gap 71 of swivel mechanism 70, and can be secured in place by passing pin 75 into passageway 72, through passageway 42 in the insert 41, and into passageway 74 of the swivel mechanism. Similarly, connection material 16 (if utilized) can be attached to the body portion 76 of the swivel mechanism 70, by passing a pin through the connection material 16 and into passageway 73. Such a configuration permits the body portion 76 to swivel about the pin disposed through passageway 73. Other types of swivel mechanisms can be substituted in apparatus 10.

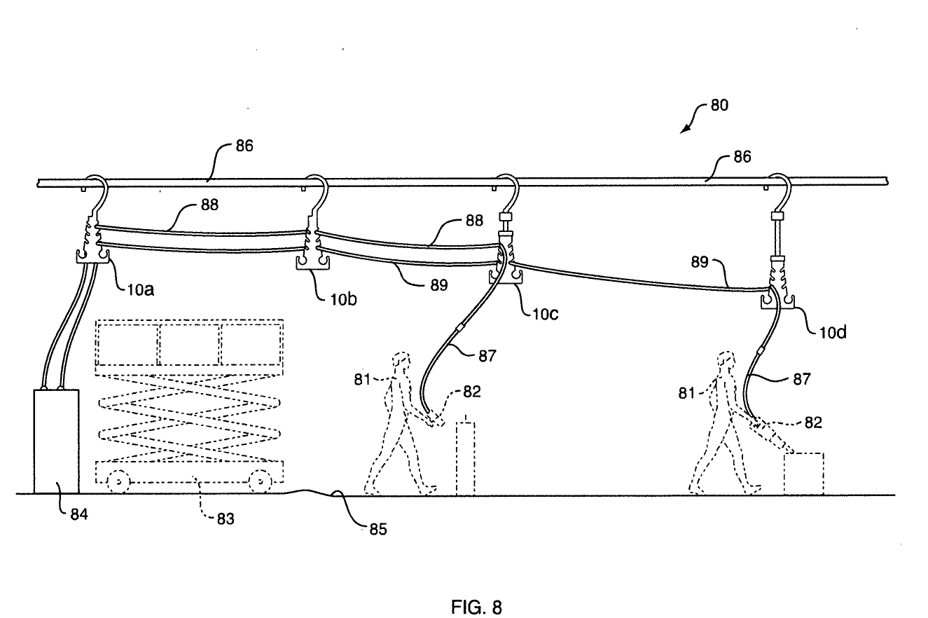

In operation and with reference to FIG. 8, a construction site 80 is illustrated in which heavy equipment 83 is operating, and multiple workers 81 are utilizing various power tools 82 to perform their tasks. The power tools 82 have power cords 87 that can be attached to a distant power supply 84 via extension cords 88 and 89. Multiple apparatuses 10A-10D can be implemented across the construction site 80 to support, and suspend the extension cords 88 and 89 away from the work area and off the ground 85. For example, apparatuses 10A-10D may be attached along a pipe 86 or other fixture above the work area. As a further example, apparatuses 10A-10D may be attached to a fixture along a wall in the work area. In fact, apparatuses 10A-10D can be attached to any item or fixture at the construction site 80 that will keep the cords out of harm's way.

Keeping the extension cords 88 and 89 off the ground and away from the work area can provide several advantages. For example, safety hazards can be reduced by preventing workers 81 from tripping and falling over extension cords strewn across the ground 85. Entanglement of multiple extension cords can be avoided. Severed cords resulting from being run over by heavy equipment 83 can be avoided, and risk of electrocution from severed cords can also be prevented.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the present invention.

What is claimed is:

1. An apparatus comprising:
a suspension end, the suspension end configured to link to a supporting fixture; and
a mounting end connected to the suspension end, the mounting end comprising one or more hooks from which electrical wires and extension cords are suspended.

2. The apparatus of claim 1 wherein the suspension end and mounting end fused together to form a single, rigid unit.

3. The apparatus of claim 1 wherein the suspension end and the mounting end are coupled through a connection link to form a flexible unit.

4. The apparatus of claim 1 wherein the suspension end is shaped like a hook to enable the suspension end and mounting end to be suspended above a work area.

5. The apparatus of claim 4 wherein the hook comprises a pointed end to enable insertion into a penetrable medium.

6. The apparatus of claim 1 wherein the suspension end comprises a clasp having a spring or other tension mechanism to secure the suspension end about the supporting fixture.

7. The apparatus of claim 1 wherein the suspension end is configured in a square or C-ring shape.

8. The apparatus of claim 7 wherein the square or C-ring configuration comprises a pin that can be removed or retracted to secure the suspension end about the supporting fixture.

9. The apparatus of claim 1 wherein the one or more hooks of the mounting end are configured in varied diameters and sizes to accommodate multiple sizes and diameters of electrical wires and extension cords.

10. The apparatus of claim 9 wherein the one or more hooks each include one of a clasp or ring to securing grip and hold electrical wires and extension cords.

11. The apparatus of claim 1 wherein the mounting end comprises an insert for connection to the suspension end.

12. The apparatus of claim 11 wherein the insert comprises a passageway through which a pin is passed to secure the mounting end to the suspension end.

13. The apparatus of claim 1 wherein the mounting end comprises an aperture for connection to the suspension end.

14. The apparatus of claim 1 wherein the connection between the suspension end and the mounting end comprises a flexible connection material.

15. The apparatus of claim 1 wherein the connection between the suspension end and the mounting end comprises a rigid connection material.

16. The apparatus of claim 1 wherein the connection between the suspension end and the mounting end comprises an adjustable cable spool including a coiled cable enabling length adjustments.

17. The apparatus of claim 1 wherein the connection between the suspension end and the mounting end comprises a swivel mechanism.
